(19) United States
(12) Patent Application Publication
(10) Pub. No.: US 2010/0051381 A1
(43) Pub. Date: Mar. 4, 2010

(54) Fall Protection Apparatus with Controlled Descent

(75) Inventors: John D. Wydner, Danville, AL (US); Jerry D. Wydner, Trinity, AL (US); Jim M. Barta, Trinity, AL (US)

Correspondence Address: LANIER FORD SHAVER & PAYNE P.C., P O BOX 2087, HUNTSVILLE, AL, 35804-2087, US

(73) Assignee: THE HUNTER SAFETY SYSTEM, INC., Danville, AL (US)

(21) Appl. No.: 12/203,556

(22) Filed: Sep. 3, 2008

(51) Int. Cl. A62B 1/14; A62B 35/00; A62B 1/16

(52) U.S. Cl. 182/5; 182/193

(57) ABSTRACT

A fall protection apparatus is described which allows for a user to effectuate a controlled descent after a fall has been arrested. The apparatus includes a tether line secured above a protected position of the user and a cinch line which frictionally engages the tether. The cinch line is attached to the user, and when the user falls, the frictional engagement of the cinch line and the tether line increase and arrests the fall. The user then pulls on a slip line attached to the cinch line to descend. Pulling on the slip line decreases the frictional engagement of the cinch line and the tether line so the user can control their descent rate based on how hard they pull on the slip line.

### BACKGROUND OF THE INVENTION

a. Field of the Invention

This invention relates to an apparatus which provides fall protection with a self controlled descent to an individual in an elevated position. When a person is elevated above the ground, such as in a tree stand used for hunting, the possibility of a fall and serious injury exists. If the person elevated above the ground simply ties themselves off, they can be trapped after a fall because they remain suspended from the safety tether with no means to descend. The current invention provides fall protection wherein a fall is arrested, and then the individual can safely descend to the ground under his or her own control. If a person is in a remote elevated position, the ability to descend under their own power can be life-saving.

b. Description of the Related Art

There are many devices which are utilized to protect against a fall. The simplest such device is tying a rope above the elevated position to be protected, and then securing the rope to the individual to be protected, preferably through a harness worn by the individual. This provides for protection from a fall, but there is no means for the individual to descend after the fall. The individual would be dependant on others for rescue after a fall. Remaining suspended for long periods is at least uncomfortable, and can be life threatening because blood flow can be restricted from the pressure a harness exerts. Therefore, if prompt discovery and rescue are uncertain, a fall protection apparatus should include some means of self descent.

One type of device used for fall protection is the industrial self-retracting lanyard. These devices are used in industrial situations to protect an individual from a fall, but they tend to be relatively heavy and require a very sturdy anchorage above the position to be protected. They also tend to be fairly expensive to purchase. The weight and bulk of these devices make them undesirable for fall protection in remote areas. The cost also makes them undesirable for many individuals.

There are rope ascenders of various sorts which are used for controlled descent. A Prusik Knot works similar to an ascender. These ascenders clamp on a rope when tension is applied to the device, so an individual is locked in place when their weight is on the ascender. Therefore, two ascenders are used, with a first ascender being off-weighted to a second so the first can be moved up or down the rope. The user then transfers their weight to first ascender, off-weighting the second ascender so it can be moved. This process is repeated to move up or down the rope. Disadvantages of this device for hunters include the complexity and skill needed to move down a safety line. The use of ascenders is also very tiring, two devices must be carried to the hunting site and connected to the safety line, and two devices must be purchased. Many of these ascenders are made of metal, which can be loud when bumped or scraped against other objects.

There are other devices which are used for a controlled descent, such as rappelling devices. A figure eight is a typical rappelling device, and the basic concept is similar to other rappelling devices such as sticht plates and rappelling racks. Most rappelling devices are made of metal. In use, a rope or tether is wrapped around a figure eight, and the figure eight is secured to the user with a carabiner. The friction as the rope wraps around the figure eight provides the force which prevents the person from descending too fast. Rappelling devices are usually positioned in front of an individual, and the rate of descent is controlled by manipulating the position of the rope relative to the rappelling device. There is a certain level of skill required to properly use a rappelling device. The device must be properly connected to the rope, the rope has to be played through the hands of the rappeller during the descent, and the rappeller has to control the position of the rope relative to the device to properly control their descent.

The current invention provides several advantages over many of the prior art devices, including combining fall protection and controlled descent, and is particularly usefull for a hunter in a tree stand. Safety is the primary purpose of a fall protection apparatus, and safety is enhanced by simplicity. The hunter may not take the time to become skilled in the use of a rappelling device, and the hunter may not have the knowledge to properly connect the rappelling device to the safety rope. Playing rope through the hands of a novice can easily result in rope burns, which would distract the hunter while suspended. Besides safety, the rappelling device has other limitations for a hunter. Noise caused by the clinking of metallic devices as they bump or scrap against other objects can frighten the game. Connecting a fall protection device in front of the hunter creates obstacles which must be avoided, distracting and limiting the hunter in the confines of a hunting stand.

Thus, a device which is light weight, small, inexpensive, simple and effective is desirable.

### SUMMARY OF THE INVENTION

The current invention provides fall protection with controlled descent for a single individual. In the simplest form, this invention includes three lines. The first line is a tether, which is simply a line suspended from above the position to be protected to the ground. The second line is a cinch line, which is attached to the individual to be protected, for example with a harness and carabiner. The cinch line is wrapped about the tether such that it forms a frictional engagement. This frictional engagement increases when a person falls and places weight on the cinch line. The increase of the frictional engagement when tension is applied to the cinch line causes the cinch line to arrest the fall of the user.

The third line is the slip line, which is utilized for a controlled descent after a fall. The slip line is attached to the cinch line, and pulling of the slip line reduces the frictional engagement of the cinch line and tether to the point where the suspended individual descends down the tether. The more strongly the slip line is pulled, the more the frictional engagement of the tether and the cinch line decrease, so the rate of descent is controlled by adjusting the strength with which an individual pulls on the slip line. A cover is also provided to protect the cinch line from inadvertent or unintentional grasping during a fall, which could result in an unintended descent of the user.

Therefore, one objective of the current invention to provide fall protection to an individual at an elevated position.

Another objective is to provide a means of self implemented descent for an individual after a fall.

Yet another objective is to provide a simple, low cost method of providing safe fall protection for an individual at an elevated position in an isolated area.

Still another objective is to provide fall protection in a remote area with an apparatus which tends to be relatively quiet.

Another objective is to provide fall protection in a remote area with an apparatus which is small and light enough to be easily transportable.

### BRIEF DESCRIPTION OF THE DRAWINGS

FIG. 1 depicts an exemplary embodiment of the fall protection apparatus with no cover.

FIG. 2 is an exemplary embodiment of the cover with portions of the fall protection apparatus visible.

FIG. 3 depicts the fall protection apparatus of FIG. 1 in use.

FIG. 4 depicts a side sectional view of the cover depicted in FIG. 2.

### DETAILED DESCRIPTION

A fall protection apparatus in accordance with an embodiment of the present disclosure provides fall protection to an individual in a remote elevated position. This situation often occurs in tree stands used while hunting, but the apparatus could be used for other purposes as well. In one embodiment, the fall protection apparatus has the components camouflaged and made of materials which make little noise when bumped or scraped, so as to prevent a hunter from signaling their position. Other materials of construction and color schemes are possible in other embodiments.

### Tether

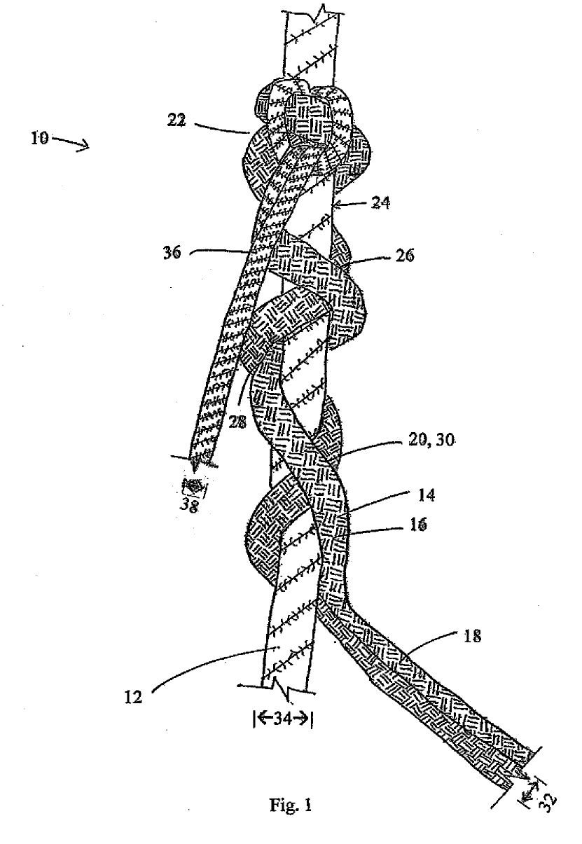

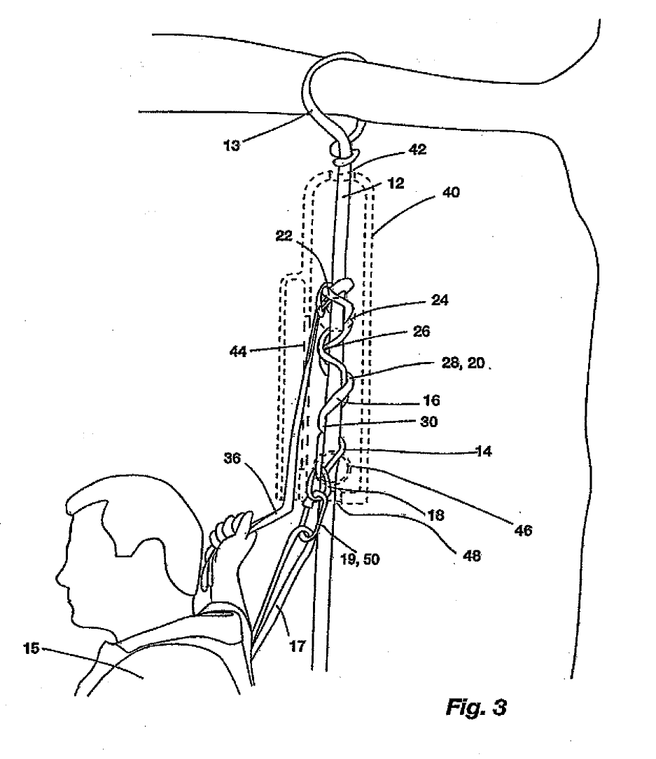

A fall protection apparatus 10 in accordance with an embodiment of the present disclosure is shown in FIGS. 1 and 3 and includes a tether line 12, also referred to as a tether 12. In one embodiment, the tether 12 is a single line to minimize weight and visual impact. If the fall protection apparatus 10 is to be used with a tree stand for hunting, low weight and low visual impact are important because the hunter has to carry the equipment to the hunting site, and stealth is required to avoid frightening game. The tether 12 is a safety line which is securely attached to a tether attachment point 13 (FIG. 3) at an elevated position, i.e., a “protected position,” with respect to a user 15 (FIG. 3).

In one embodiment, the tether 12 is made of an elastic material. In such an embodiment, when the tether 12 stretches, the impact on the user 15 during a fall is minimized. When the tether 12 first tightens, some of the force of the fall is transferred to the user 15. The rest of the force of the fall is transferred to the user 15 as the line stretches, and the entire force of the fall is spread out over the length by which the tether 12 stretches. This reduces the impact on the user 15 and results in a safer product. In one embodiment, tether 12 is a rock climbing rope, which provides this elasticity. Further, in one embodiment, the tether 12 is comprised of up to 100% nylon, and has a diameter 34 of 11 to 15 millimeters, for example, 13 millimeters.

### Cinch Line

The user 15 is attached to a cinch line 14 with a harness 17 that is coupled to the user's back and a carabiner 19. The cinch line 14 frictionally engages the tether line 12, and the frictional force arrests the fall of the user 15. The cinch line 14 has two sections; a knot section 16 and an attachment section 18. The knot section 16 wraps about the tether 12, and frictionally engages the tether 12. The attachment section 18 is not wrapped about the tether 12, and is the portion of the cinch line 14 to which the user 15 is attached.

The manner of wrapping the cinch line 14 about the tether 12 results in the knot section 16 forming the frictional engagement with the tether 12. The knot section 16 wraps around the tether 12 and forms crosses 20 where the cinch line 14 crosses over itself adjacent to the tether 12. The crosses 20 are numbered with the lowest numbered cross being the furthest from the attachment section 18. The crosses are numbered first, second, third, fourth, fifth, etc., 22, 24, 26, 28, 30. In one embodiment, there are at least three crosses 20 for the fall protection apparatus 10, but five or more crosses 20 can be used. Successive crosses 20 are on opposite sides of the tether 12, so every other cross 20 will be in approximately the same position around the tether. Therefore, the third cross 26 would generally be below the first cross 22, and on the same side of the tether 12. The crosses 20 can move along the tether 12, so the position of the crosses 20 can be shifted such that the orientation of the tether 12 in relation to the crosses 20 varies.

The attachment section 18 is connected to the user 15, for example through the safety harness 17 worn by the user 15 and the carabiner 19. The use of a locking carabiner 19 is suggested to prevent unintended separation of the fall protection apparatus 10 and the individual 15. The attachment section 18 can form a simple loop to facilitate connection to the user 15, but other forms are acceptable as long as they provide for an effective method of securely connecting the cinch line 14 with the user 15. In one embodiment, loose ends of the attachment section 18 are knotted to form a loop for creating a shape to facilitate the connection of the user 15 and the cinch line 14.

Because the user 15 is connected to the attachment section 18, when the user 15 falls, the weight of the user 15 puts tension on the attachment section 18. This tension increases the frictional engagement of the knot section 16 and the tether 12 to the point that the fall of the user 15 is arrested. The attachment section 18 is positioned below the knot section 16 in use, and the first cross 22 is at the top of the knot section 16.

When the first cross 22 and the last cross 20 are moved closer together, it is referred to as “constricting the knot section 16.” Constriction of the knot section 16 along the tether 12 minimizes the frictional engagement of the cinch line 14 and tether 12. When tension is applied to the attachment section 18, the crosses 20 are urged towards vertical alignment, but the tether 12 between sequential crosses 20 prevents the crosses 20 from vertically aligning. The attachment section 18 tension does tend to cause the tether 12 to distort, so the crosses 20 are more vertically aligned than in the absence of tension, and the tether 12 tends to bow or snake between the crosses 20 instead of hanging vertical. The frictional engagement of the tether 12 and cinch line 14 increases as the bowing or snaking of the tether 12 through the knot section 16 increases. The tether 12 can bow more when the knot section 16 is more expanded, so compression of the knot section 16 tends to reduce the frictional engagement of the tether 12 and knot section 16.

In the absence of tension on the attachment section 18, the knot section 16 can be pushed up or down the tether line 12 because the frictional engagement between the knot section 16 and the tether 12 is small. There is no strong force tending to bow or distort the tether 12, so the knot section 16 can slide along the tether 12. The knot section 16 is compressed along the tether 12 by pushing on one end of the knot section 16. This minimizes the bowing of the tether 12 between crosses 20, and minimizes the frictional engagement of the tether 12 and knot section 16 sufficiently for the knot section 16 to slide along the tether 12.

By pushing down on the first cross 22, the knot section 16 compresses and slides along the tether 12. In a similar manner, if the user were to push on the bottom cross 20, which is the fifth cross 30 in FIG. 1, it would serve to compress the knot section 16 and slide the cinch line 14 up the tether 12. This allows the cinch line 14 to be moved to different points so the user 15 can easily create a protected position anywhere along the tether 12. In fact, the user 15 can maintain fall protection as he or she climbs up or down along the tether 12 simply by moving the cinch line 14 along as the user's elevation changes.

In one embodiment, the cinch line 14 has a diameter 32 which is smaller than a diameter 34 of the tether 12. In one embodiment, the cinch line diameter 32 ranges from 6 to 10 millimeters, e.g., 8 millimeters.

In one embodiment, the cinch line diameter 32 is smaller than the tether diameter 34. The cinch line 14 can made from rock climbing rope comprised of nylon, with the nylon comprising up to 100% of the material. It is not required for the cinch line 14 to be stretchy because the stretch of the tether 14 reduces the impact of the fall for the user 15. However, the cinch line 14 can be stretchy without harming the functionality of the fall protection apparatus 10.

### Slip Line

A slip line 36 is attached to the first cross 22 of the knot section 16. Pulling down on the slip line 36 compresses the knot section 16, and therefore the frictional engagement of the knot section 16 and the tether 12 is reduced. The harder the slip line 36 is pulled, the more the frictional engagement of the knot section 16 and the tether 12 is reduced. At some point the frictional engagement is reduced to the point the suspended user 15 begins to slide down the tether 12. The rate of descent can be controlled by how hard the slip line 36 is pulled. As the user 15 pulls on the slip line 36 harder, the rate of descent increases. If the user 15 becomes frightened and releases the slip line 36, the frictional engagement increases and the user's 15 descent is arrested.

For the slip line 36 to best function, it should be pulled in a downward manner. This is needed to compress the knot section 16 and reduce the bows and snaking of the tether 12. Therefore, the fall protection apparatus 10 must be configured such that a suspended user 15 pulling on the slip line 36 pulls the first cross 22 towards the attachment section 18, thereby compressing the knot section 16.

The slip line 36 is easily attached to the first cross 22, for example by being looped and knotted around the first cross 22. The slip line 36 can be attached to the first cross 22 differently in other embodiments. For example, the slip line 36 can be being sewed or glued to the first cross 22. In one embodiment, the slip line 36 is small in diameter because it does not support the weight of the user 15, and a smaller line is lighter and less bulky. Therefore, the slip line diameter 38 can be smaller than the diameter of the cinch line 32 or the tether 34.

### Cover

The frictional engagement of the knot section 16 and the tether 12 is reduced when the knot section 16 is compressed by pulling on the slip line 36. It is also possible to decrease the frictional engagement of the knot section 16 and the tether 12 by grabbing the knot section 16 manually and compressing it. When a person 15 at elevation falls, it can be a natural, reflexive action to grasp for a safety tether 12. This natural, instinctive motion can result in the user 15 grasping the knot section 16, resulting in an unplanned and unexpected descent. This descent could result in serious injuries if it extended to the ground, and even if the individual 15 were to let go of the knot section 16 before hitting the ground, he could sustain injuries from the unplanned descent, such as rope burns to the hands.

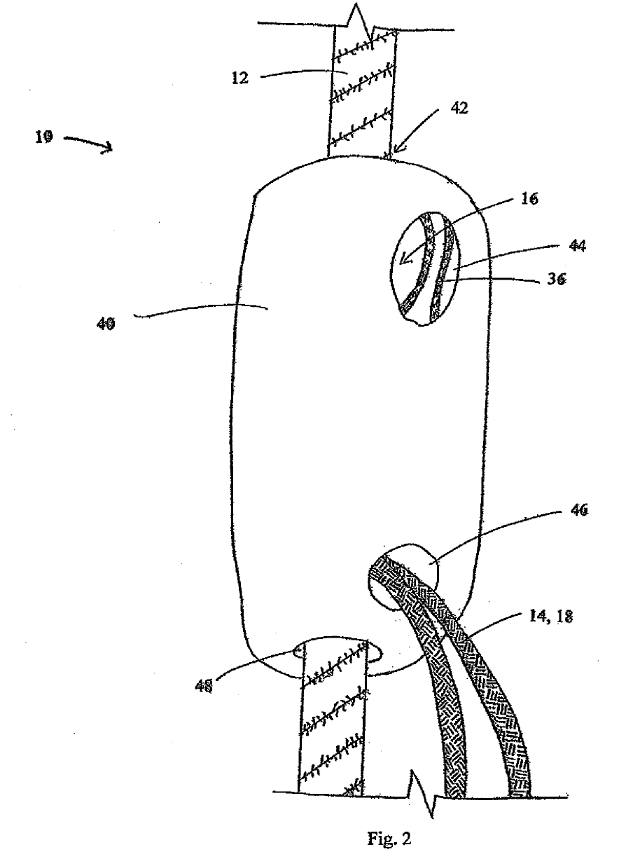

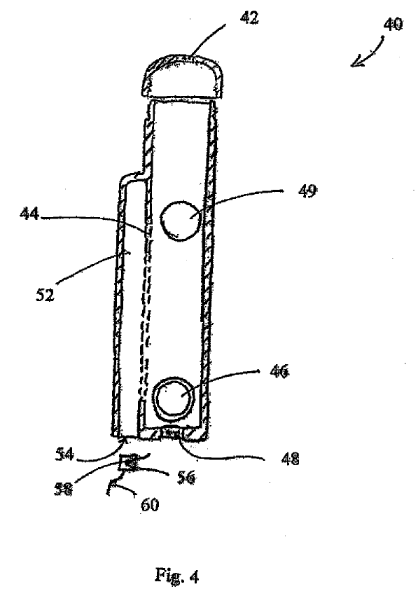

To prevent this, a cover 40 may be used over the knot section 16, as seen in FIG. 2 and shown in dashed lines in FIG. 3. An alternative embodiment of the cover is shown in FIG. 4. Any reflexive grabbing of the tether 12 or the fall protection apparatus 10 does not result in an unintended descent because the cover 40 protects the vital portions of the fall protection apparatus 10. as shown in FIG. 3 and 4. In one embodiment, the cover 40 is made of a material that doesn't clink or make much noise when impacted when the fall protection apparatus 10 is used by hunters who don't want to frighten their prey. A coating can be applied to the outside of the cover which minimizes impact noises, such as clinking.

In one embodiment, the cover 40 has several openings. The openings can include a top opening 42, a slip line opening 44, a cinch line opening 46, and a bottom opening 48. The top opening 42 and bottom opening 48 allow the tether 12 to pass through the cover 40. In one embodiment, the top opening 42 is large enough not to catch on the knot section 16, so if an individual falls and grabs the cover 40, the cover 40 will not abut and compress the knot section 16, potentially causing an unintended descent. Alternatively, the top opening 42 can be small, but the cover 40 can be dimensioned such that the first cross 22 remains below the top opening 42 at all times. This is accomplished by constructing the cover 40 such that the distance between the top opening 42 and the cinch line opening 46 is greater than the distance from the first cross 22 to the carabiner 19.

The knot section 16 can be moved up or down the tether 12 when the cover 40 is utilized. If the cover extends above the first cross 22, a thumb opening 49 can be included in the cover, as shown in FIG. 4. The thumb opening 49 allows access to the first cross 22, so the user 15 can insert their thumb or finger through the thumb opening 49 and press down on the first cross 22 to lower the knot section 16 down the tether 12. A flap can be provided over the thumb opening 49 to prevent inadvertent contact with the knot section 16. If the top opening 42 is large enough not to abut the knot section 16, the user 15 pushes down on the first cross 22 through the top opening 42, as seen in FIGS. 2 and 3. The bottom opening 48 is sized to abut the knot section 16, so pushing the cover 40 upwards serves to compress the knot section 16 and move the cinch line 14 up on the tether 12.

To prevent the attachment section 18 from sliding up into the cover 40, a catch 50 is used. The catch 50 is dimensioned such that it will not pass through the cinch line opening 46, and is connected to the attachment section 18 outside of the cover 40. The carabiner 19 can serve as the catch 50, or the catch 50 can be formed by a simple knot in the attachment section 18. The catch 50 is utilized to maintain the proper positioning of the cinch line 14 relative to the cover 40.

The slip line opening 44 allows access to the slip line 36 for the user 15. In one embodiment, the slip line 36 does not protrude through the cover 40 before a fall. This is to prevent the accidental or reflexive grabbing of the slip line 36 and an associated unintended descent. The slip line 36 is accessible so that after a user 15 has fallen and the fall has been arrested, the user 15 can access the slip line 36 through the slip line opening 44. After a fall, when the user 15 is suspended, there is time to regain composure and calmly and rationally proceed. In one embodiment, the slip line 36 pulls the first cross 22 downward, so the slip line opening 44 is positioned below the first cross 22. This allows a suspended individual 15 to pull on the slip line 36 and compress the knot section 16.

An alternative embodiment of the cover 40 is shown in FIG. 4, which includes a slip line compartment 52. The slip line compartment 52 is attached to the cover 40, and houses the slip line 36. The slip line 36 enters the slip line compartment 52 through the slip line opening 44, and access to the slip line 36 is through a slip line compartment opening 54. A break away plate 56 seals the slip line compartment opening 54. A pull opening 58 in the break away plate 56 provides access for the user 15. A pull line 60 passes through the pull opening 58, and protrudes below the slip line compartment 52. The pull line 60 should be secured above and below the break away plate 56 to keep the pull line 60 in position. When the user 15 is suspended, he pulls on the pull line 60 to disconnect the break away plate 56 from the slip line compartment 52. The user 15 then retrieves the slip line 36 from the slip line compartment 52 through the slip line compartment opening 54, and lowers himself by pulling on the slip line 36.

In another embodiment, the slip line 36 is not used to apply tension to the knot section 16 to move the knot section 16 down the tether 12. Rather, a mechanical means (not shown) is used to apply pressure to the top of the knot section 16 to move the knot section 16 down the tether 12. For example, the mechanical means may be a plate (e.g., washer) inside the cover 40 that is pulled down by a string (not shown) attached to the cover 40 until the plate contacts the top of the knot section 16. When the plate contacts the knot section 16 with enough force, the knot section 16 will move down the tether 12 in the manner described herein. In other embodiments, other mechanical means are used to move the knot section 16 down the tether 12

### Method

The present disclosure further encompasses a method of protecting against an accidental fall, as best seen in FIGS. 1 and 3. The method includes attaching a tether line 12 to a tether attachment point 13 above the elevated position to be protected, and letting the tether 12 hang to the ground. A cinch line 14 is positioned about the tether 12 such that a frictional engagement of the cinch line 14 and tether 12 increases when tension is applied to an attachment section 18 of the cinch line 14. In one embodiment, the cinch line 14 has a smaller diameter 32 than the tether diameter 34. The user 15 is connected to the attachment section 18, and the frictional engagement of the tether 12 and a knot section 16 of the cinch line 14 arrests a fall because of the tension the suspended user 15 places on the attachment section 18.

A slip line 36 is connected to the knot section 16 such that tension applied to the slip line 36 reduces the frictional engagement of the cinch line 14 and the tether line 12. A cover 40 may be provided over the knot section 16 to prevent the accidental grabbing of the knot section 16 or the slip line 36 during a fall. The cover 40 may include a slip line opening 44, where the slip line 36 is accessible through the slip line opening 44. After a fall, an individual 15 can intentionally retrieve the slip line 36 and descend under control.

In one embodiment, the cinch line 14 is moved along the tether 12 by applying pressure to the knot section 16, in the absence of pressure on the attachment section 18. The pressure should be applied to either the top or bottom of the knot section 16. By moving the cinch line 14 along the tether 12 with an individual 15, fall protection is provided during a change in position of the individual 15.

The fall protection apparatus of the present disclosure can be used in a wide variety of applications where a user desires to descend down a rope. Some examples of such uses include rock climbing, rappelling, descending from a helicopter, or construction activities at elevated positions.

While the fall protection apparatus has been described with respect to a limited number of embodiments, those skilled in the art, having benefit of this disclosure, will appreciate that other embodiments can be devised which do not depart from the scope of the present disclosure.

We claim:

1. A fall protection apparatus providing a controlled descent comprising:
a tether line for securing above a protected position;
a cinch line having a knot section and an attachment section, the knot section frictionally engaging the tether line such that tension applied to the attachment section increases the frictional engagement of the knot section and the tether line; and
a slip line attached to the cinch line wherein tension applied to the slip line diminishes the frictional engagement of the cinch line with the tether line so a person suspended from the cinch line descends down the tether line when sufficient tension is applied to the slip line.

2. The fall protection apparatus of claim 1 wherein the cinch line and the tether line each have a diameter, and the cinch line diameter is smaller than the tether line diameter.

3. The fall protection apparatus of claim 1 further comprising a cover, wherein the cover is received about the tether line and the knot section of the cinch line.

4. The fall protection apparatus of claim 3 wherein the cover includes a top opening, a slip line opening, a cinch line opening, and a bottom opening, wherein the tether line enters and exits the cover through the top opening and the bottom opening, the attachment section passes through the cinch line opening, and the slip line is accessible through the slip line opening.

5. The fall protection apparatus of claim 4 further comprising a slip line compartment attached to the cover, wherein the slip line is partially received in the slip line compartment for access when necessary.

6. The fall protection apparatus of claim 1 wherein the tether line and the cinch line are comprised of nylon.

7. The fall protection apparatus of claim 6 wherein the cinch line wraps about the tether line to form at least a first, second and third cross, wherein each cross is formed by the cinch line passing over itself adjacent to the tether line, wherein a cross with a lower numeral is further from the attachment section than a cross with a higher numeral, and wherein the slip line is attached at the first cross.

8. The fall protection apparatus of claim 7 wherein the knot section comprises at least 5 crosses.

9. A fall protection apparatus providing a controlled descent comprising:
a tether line for securing above a protected position;
a cinch line wrapped around the tether line to form at least a first, second and third cross wherein each cross is formed by the cinch line crossing itself adjacent the tether line, the cinch line having a knot section including the crosses and an attachment section for connecting a person to the cinch line; and
a means for moving the knot section down the tether line in as controlled descent.

10. The fall protection apparatus of claim 9 wherein the means for moving the knot section down the tether line is a slip line secured to the cinch line.

11. The fall protection apparatus of claim 9 further comprising a cover received about the knot section.

12. The fall protection apparatus of claim 11 wherein the cover includes a top opening, a slip line opening, a cinch line opening, and a bottom opening, wherein the tether line passes through the top and bottom openings, the attachment section passes through the cinch line opening, and the slip line is accessible through the slip line opening.

13. The fall protection apparatus of claim 12 further comprising a slip line compartment attached to the cover, wherein the slip line opening opens into the slip line compartment, and the slip line passes through the slip line opening into the slip line compartment.

14. The fall protection apparatus of claim 9 wherein the cinch line and the tether line each have a diameter, and the cinch line diameter is less than the tether line diameter.

15. The fall protection apparatus of claim 14 wherein the tether line and the cinch line are comprised of nylon.

16. The fall protection apparatus of claim 9 wherein the knot section includes at least 5 crosses.

17. The fall protection apparatus of claim 10 wherein the slip line is secured to the cinch line first cross.

18. A method for protecting an individual from a fall from an elevated position comprising:
(a) suspending a tether line from a point above the protected, elevated position;
(b) positioning a cinch line about the tether line such that a frictional engagement of the cinch line with the tether line is increased when tension is applied to an attachment section of the cinch line;
(c) connecting the individual to the attachment section of the cinch line;
(d) connecting a slip line to the knot section of the cinch line, wherein tension applied to the slip line reduces the frictional engagement of the cinch line and the tether line when tension is applied to the attachment end of the cinch line.

19. The method of claim 18 further comprising:
Arresting a fall by the individual from the protected position by the frictional engagement of the cinch line and the tether line; and
pulling the slip line to reduce the frictional engagement of the cinch line and tether line to effectuate a controlled descent of the suspended individual.

20. The method of claim 17 further comprising providing a cover over the knot section of the cinch line for preventing the grabbing of the knot section during a fall.

21. The method of claim 19 further comprising positioning the slip line within the cover to prevent a reflexive grasping of the slip line during a fall, and positioning the slip line such that the slip line is accessible through a slip line opening in the cover so a suspended individual can retrieve and pull the slip line to effectuate a controlled descent after a fall.

22. The method of claim 17 further comprising moving the cinch line along the tether line during a change of the protected position to maintain protection at varying elevations.

23. The method of claim 21 further comprising applying pressure to the knot section in the absence of tension on the attachment section to move the knot section along the tether line.
